(19) United States
(12) Patent Application Publication
(10) Pub. No.: US 2017/0225109 A1
(43) Pub. Date: Aug. 10, 2017

(54) NESTED FILTER FOR USE IN A MIST COALESCER UNIT

(71) Applicants: Mark Allen Gerken, Franklin, OH (US); Greg M. Gottlieb, Cincinnati, OH (US); Ryan Patrick Kelly, Milford, OH (US); John Alan Krogue, Mineral Wells, TX (US); Shagufta Usman Patel, Aledo, TX (US); Prashant Shashank Kulkarni, Aledo, TX (US)

(72) Inventors: Mark Allen Gerken, Franklin, OH (US); Greg M. Gottlieb, Cincinnati, OH (US); Ryan Patrick Kelly, Milford, OH (US); John Alan Krogue, Mineral Wells, TX (US); Shagufta Usman Patel, Aledo, TX (US); Prashant Shashank Kulkarni, Aledo, TX (US)

(73) Assignee: United Air Specialists, Inc., Cincinnati, OH (US)

(21) Appl. No.: 15/040,860

(22) Filed: Feb. 10, 2016

(51) Int. Cl. B01D 46/00; B01D 46/24

(52) U.S. Cl. CPC B01D 46/003; B01D 46/0004; B01D 46/0021; B01D 46/0023; B01D 46/2414; B01D 2275/10; B01D 2277/10

(57) ABSTRACT

A droplet coalescing filter cartridge is provided. The filter cartridge includes an outer filter tube and an inner filter tube disposed within the outer filter tube, and is configured to provide parallel filtration of a fluid flow. The filter includes a depth media configured to coalesce fine droplets or aerosols from an air flow. The filter cartridge is suitable for use in a coalescing filter assembly including the filter cartridge and a secondary filter element.

### FIELD OF THE INVENTION

This invention generally relates to an air filter. More particularly, this invention relates to filters suitable for coalescing a liquid mist or aerosol from an air flow.

### BACKGROUND OF THE INVENTION

Many industrial processes result in the creation of fine particulates and/or aerosols, and their dispersion in to the immediate environment. This dispersion may negatively affect air quality in the area. A coalescing filter collects small particles and/or liquid droplets carried by a fluid stream, such as an air flow, to collect on the filter. When liquid droplets are collected, they will generally combine into larger droplets. Often, the combined droplets become heavy enough to flow downward under the pull of gravity, thereby draining out of the bottom of the filter for collection or drainage.

Typically, standards for removing particulates and aerosols from a work environment are set by federal, state, and/or local governments, and may require improvements to known coalescing filters. In some environments, high flow volumes through coalescing filters may be required to meet air quality standards.

The invention provides such an improved filter. These and other advantages of the invention, as well as additional inventive features, will be apparent from the description of the invention provided herein.

### BRIEF SUMMARY OF THE INVENTION

In one aspect, the invention provides a filter cartridge having a first cylindrical filter element including first and second circular ends. A second cylindrical filter element is arranged in parallel fluid circuit with the first cylindrical filter element. Fluid flowing through the filter cartridge flows through either the first cylindrical element or the second cylindrical filter element. The second cylindrical element includes third and fourth circular ends. The second cylindrical element is telescopically nested inside of the first cylindrical filter element, with a cylindrical flow channel between the first and second cylindrical elements. The filter cartridge also includes a first end cap, second end cap, and third end cap. The first end cap caps the first circular end and the third circular end of the first and second cylindrical filter elements. The second end cap caps the second circular end of the first cylindrical filter element. The third end cap caps the fourth circular end of the second cylindrical filter element.

In another aspect, the first cylindrical filter element and second cylindrical filter element each include multiple layers of laminated filter media in a wrapped configuration.

In another aspect, the first cylindrical filter element includes at least a first media material and a second media material, where the first media material is laminated radially outward from the second media material. The second cylindrical filter element also includes at least the first media material and the second media material, where the first media material is laminated radially inward from the second media material.

In another aspect, the first cylindrical filter element includes at least two layers of laminated filter media with at least two different removal ratings.

In another aspect, the first cylindrical filter element includes a non-pleated depth media with a thickness of at least 0.20 inches measured from an upstream face to a downstream face. The non-pleated depth media may include at least two layers. In some aspects, the non-pleated depth media includes between 3 to 6 layers. In some aspects, one of the layers may include an oleophilic or hydrophilic coating.

In another aspect, the filter media of the first cylindrical filter element is a droplet coalescing filter media.

In another aspect, the filter media is a depth media including a first wound filter layer and a second wound filter layer downstream of the first wound filter layer. The second wound filter layer has a higher particle removal rating than the first wound filter layer.

In another aspect, the first end cap includes an annular dome positioned between the first cylindrical filter element and the second cylindrical filter element.

The invention also provides method of filtering an air flow having liquid droplets in the air flow. The method includes the steps of providing a filter cartridge according to any of the aspects of the invention to coalesce the liquid droplets from the air flow, and draining the coalesced liquid droplets from a bottom end of the filter cartridge. The method also includes the step of providing a secondary filter element downstream of the filter cartridge wherein the secondary filter element has a higher particle removal rating than the filter cartridge.

In yet another aspect, the invention provides a filter cartridge including a first non-pleated annular filter element having first and second annular ends. The filter cartridge also includes a second non-pleated annular filter element, which is arranged in parallel fluid circuit with the first filter element. Fluid flowing through the filter cartridge flows through either the first element or the second filter element. The second element is telescopically nested inside of the first filter element with a flow channel therebetween, and the second non-pleated annular filter element has third and fourth annular ends. Each of the first and second non-pleated annular filter elements comprise coalescing filter media. The coalescing filter media is in the form of a tube having a thickness of at least 0.2 inch between an upstream face and a downstream face. The filter cartridge also includes a first end cap capping the first annular end and the third annular end of the first and second filter elements, a second end cap capping the second annular end of the first filter element, and a third end cap capping the fourth annular end of the second filter element.

In another aspect, the second end cap of the filter cartridge also includes a radial support flange. The radial support flange can further include an annular centering taper.

In another aspect, the second end cap of the filter cartridge also includes an axially-oriented sealing member.

In still another aspect, the invention provides an air filtration assembly. The assembly includes a housing and a header plate supported by the housing. The header plate includes a first plurality of openings. The assembly also includes a plurality of filter cartridges. Each filter cartridge includes a first filter element and a second filter element, the second filter element telescopically nested within the first filter element and arranged in parallel fluid circuit with the first filter element. Each filter cartridge also includes a mounting flange and an axial sealing member. The assembly also includes a tube sheet having a second plurality of openings. Each of the plurality of filter cartridges is coupled to the header plate by its respective mounting flange within the first plurality of openings. The header plate is moveable between a first position and a second position. The axial sealing member of each filter cartridge is in sealing contact with the tube sheet at an opening of the second plurality of openings when the header plate is in the second position.

In another aspect, the assembly also includes a secondary filter element downstream of the plurality of filter cartridges. The secondary filter element may have a higher particle removal efficiency rating than the plurality of filter cartridges.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective partial cross-sectional view of a filter cartridge of the present invention;

FIG. 2 is a cross-sectional view of the filter cartridge of shown in FIG. 1

FIG. 2A is an enlarged detail view of a portion of the filter cartridge shown in FIG. 2.

FIG. 3A is a partially schematic detail cross-sectional view of the filter cartridge shown in FIGS. 1 and 2;

FIG. 3B is a partially schematic detail cross-sectional view of an alternate embodiment of the filter cartridge shown in FIGS. 1 and 2; and

FIG. 4 is a perspective partial cross-sectional view of another embodiment of a filter cartridge assembly of the present invention;

FIG. 5 is a side view of a filter assembly of the present invention in a first position and employing the filter cartridge of FIG. 4;

FIG. 5A is an enlarged detail view of a portion of the filter assembly shown in FIG. 5;

FIG. 6 is a side view of a filter assembly of the present invention in a second position and employing the filter cartridge of FIG. 4;

FIG. 6A is an enlarged detail view of a portion of the filter assembly shown in FIG. 6;

FIG. 7 is perspective view of a filter cartridge assembly of the present invention and employing the filter cartridge of FIG. 4;

FIG. 8 is a schematic representation of a filtering system including the filter cartridge of the present invention shown in FIG. 1; and

FIG. 9 is a schematic representation of another embodiment of a filtering system including the filter cartridge of the present invention shown in FIG. 4; and

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

As will be appreciated, filtration of fine particulate and droplets from fluid flows may be required in a variety of applications. Exemplary filtration applications using various embodiments of the filter cartridge 10 are described below with reference to the drawings.

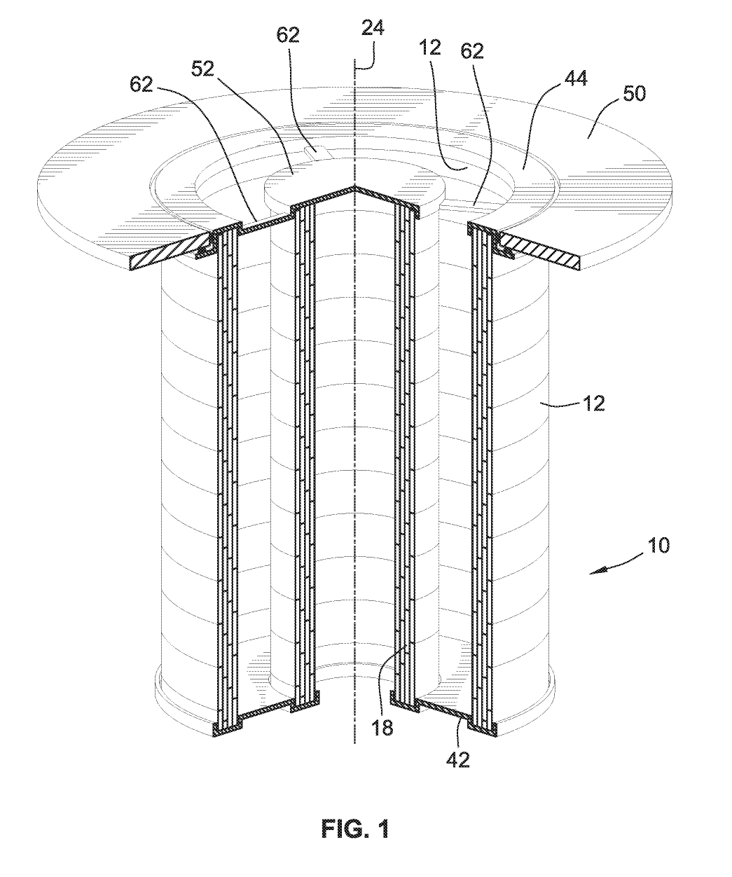

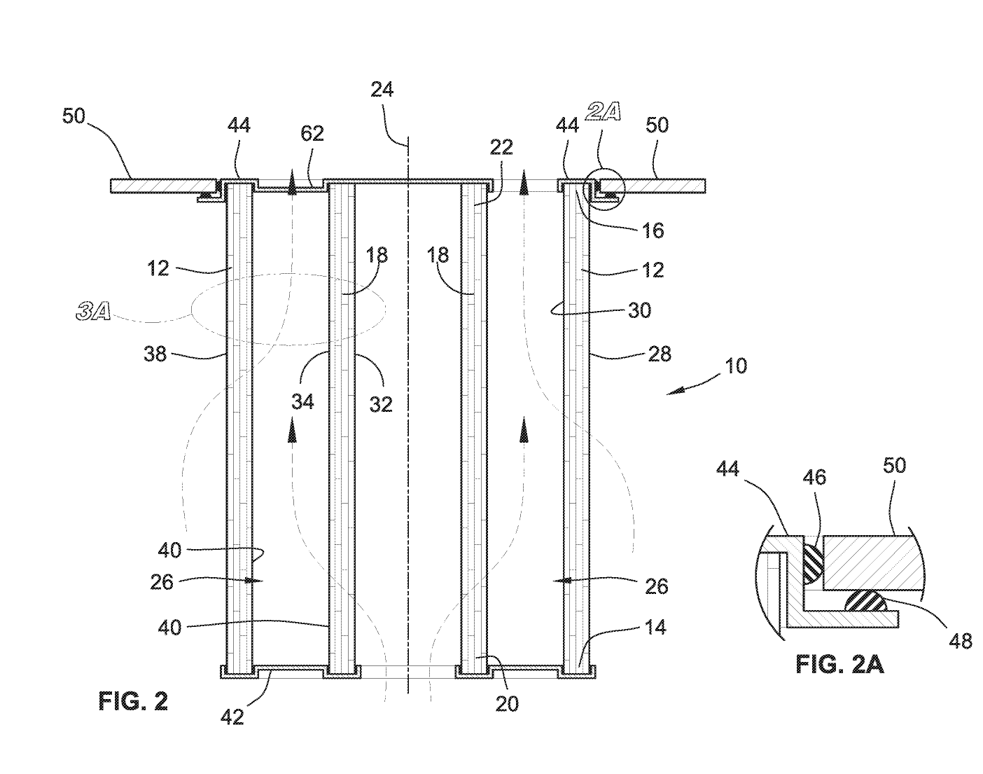

Referring to FIGS. 1 and 2, an exemplary embodiment of a filter cartridge 10 of the present invention is shown. In such a filter cartridge 10, a fluid containing various contaminants may be filtered in parallel fluid flow pathways. A filter cartridge 10 may be configured with a compact filter design including both an outside-to-in filtration element and an inside-to-out filtration element, as will be described in further detail.

In one embodiment, filter cartridge 10 includes an outer cylindrical filter tube 12 having a first end 14 and a second end 16, and an inner cylindrical filter tube 18 having a third end 20 and a fourth end 22. Inner cylindrical filter tube 18 is telescopically nested inside of the outer cylindrical filter tube 18 about filter longitudinal axis 24, defining an annular flow channel 26 between outer cylindrical filter tube 12 and inner cylindrical filter tube 18. Outer tube 12 and inner tube 18 are thereby configured to provide parallel filtration of fluid flow 36, such that a fluid flowing through the filter cartridge flows through either the outer cylindrical tube 12 or the inner cylindrical filter tube 18.

Outer cylindrical filter tube 12 includes radially outward face 28 and a radially inward face 30. Inner cylindrical filter tube 18 also includes a radially inward face 32 and a radially outward face 34. These various faces 28, 30, 32, 34 for inlet and outlet faces depending upon direction of fluid flow. In the flow orientation shown in FIGS. 1 and 2, a fluid flow to be filtered passes through one of inner and outer filter tubes 12, 18 as shown by flow arrows 36. When configured for the fluid flow in the direction shown by flow arrows 36, radially outward face 28 and radially inward face 32 are upstream flow faces 38, and radially inward face 30 and radially outward face 34 are downstream flow faces 40. In this configuration, outer filter tube 12 is configured for outside-to-inside fluid flow, while inner filter tube 18 is configured for inside-to-outside fluid flow. In an alternate embodiment, the fluid flow to be filtered may be in the reverse direction from the flow arrows 36.

Herein liquid and gas applications are contemplated, and the word “fluid” is used to encompass both or other appropriate fluid possibilities. In one embodiment and an exemplary application, the fluid to be filtered is an air stream containing a fine dispersion or mist of a liquid, such as aerosols of a water-soluble cutting coolant solution or a hydrocarbon-based cutting oil.

In a typical embodiment, filter tubes 12, 18 are provided with end caps 42, 44, and 52 and configured for installation in a tube sheet 50. A lower end cap 42 is provided distal to tube sheet 50. Lower end cap 42 sealingly couples lower end 14 of outer tube 12 to lower end 20 of outer tube 18. Filter cartridge 10 is further provided with an outer end cap 44. As shown in FIGS. 1 and 2, outer end cap 44 is configured to couple filter cartridge 10 to tube sheet 50. An inner end cap 52 is provided on upper end 22 of inner filter tube 18. The end caps 42, 44, 52 may be permanently connected to and each form a fluid-tight seal with the respective filter tubes 12, 18 such that fluid must pass through either the outer filter tube 12 or the inner filter tube 18 to reach the annular flow channel 26 of filter cartridge 10.

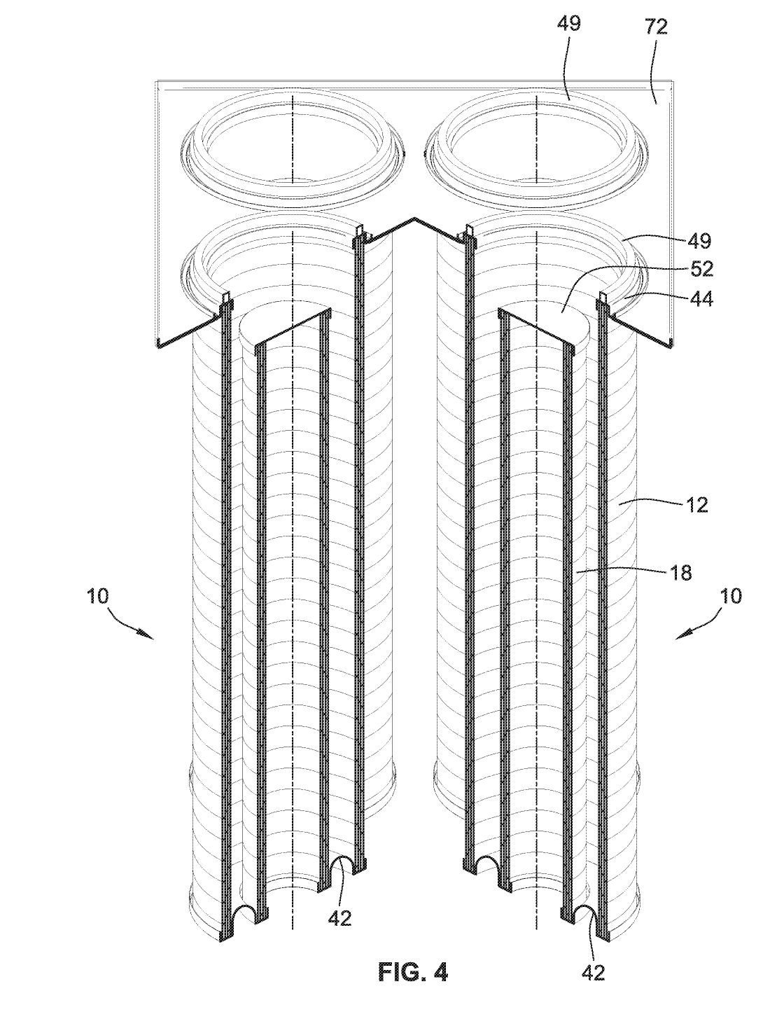

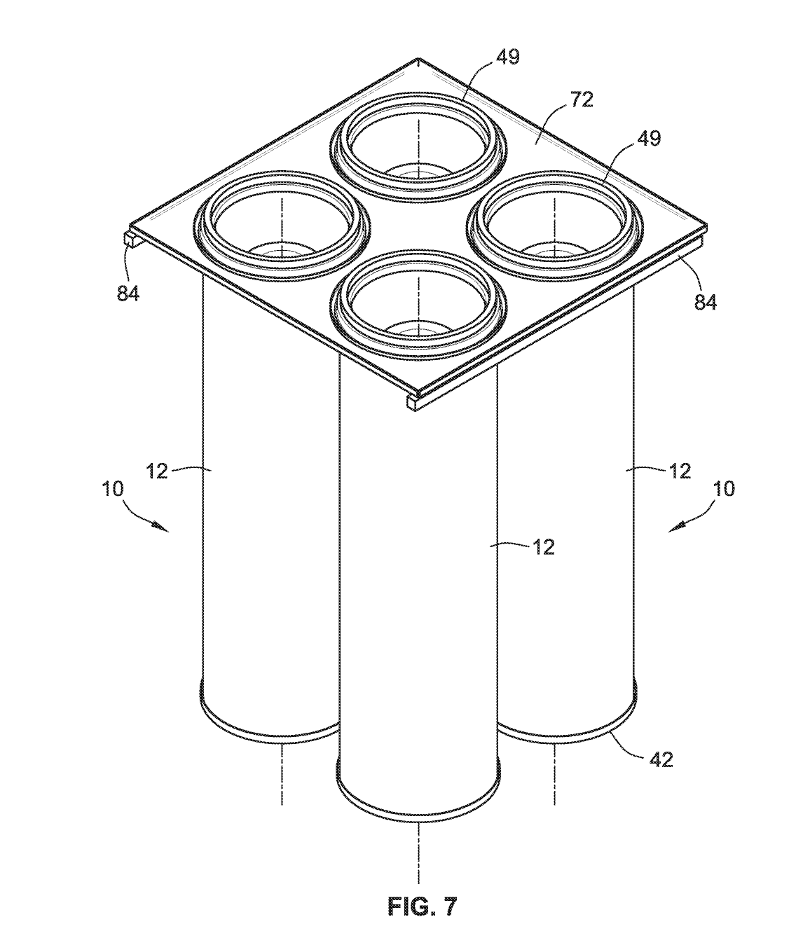

Operating together, lower end cap 42 and inner end cap 52 support inner filter tube 18 within outer filter tube 12. Outer end cap 44 may optionally be coupled to inner end cap 52 by one or more support ribs 62. In other embodiments, inner end cap is not support by ribs 62 and outer end cap 44. In the embodiment shown in FIGS. 4-7, the length of inner filter element 18 is shorter than the length of outer filter element 12, such that inner end cap 52 does not extend the full length of annular flow channel 26 along longitudinal axis 24.

End caps 42, 44, and 52 may be formed from any material compatible with the fluid being filtered and the filtering conditions. In one embodiment, end caps may be formed from a metal via a spinning mandrel or stamping. In other embodiments, end caps may be formed from a plastic or resin, for example by injection molding or casting processes. Filter tubes 12, 18 may be secured into end caps 42, 44, 52 using an adhesive or binder, such as a plastisol, polyurethane, or other suitable adhesive. In other embodiments, filter tubes 12, 18 may be mechanically secured into end caps, for example by crimping. In still other embodiments, filter tubes 12, 18 may be integrally bonded to the end caps by the material of the end caps themselves, to thereby secure the filter tubes 12, 18 into the end caps.

A generally fluid-tight seal between outer end cap 44 and partition 50 may be provided by one or more sealing members. Typical sealing members may include a radially-oriented seal 46 or an axially-oriented compression seal 48. Sealing members 46 and 48 may be any suitable gasket material, for example urethane, vitril, viton, neoprene, silicone, or polyvinyl chloride. Alternatively, no seal may be provided because coalescing generally involves redirecting a fluid flow such that at joints where small gaps might occur some coalescing still occurs with very limited bypass, and also considering that a secondary filter is often used in coalescing systems (as discussed in further detail below).

Thus, preferably the nested filter cartridge 10 is arranged in fluid series with a downstream finish filter that has a MERV rating of greater than 9, more preferably greater than 12, and still more preferably greater than at least 16.

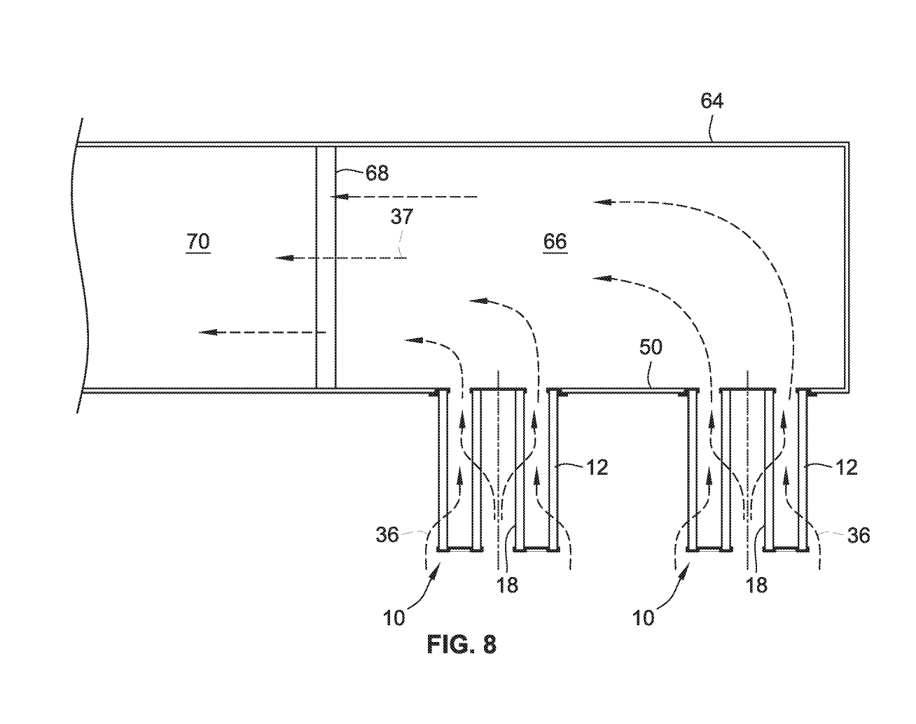

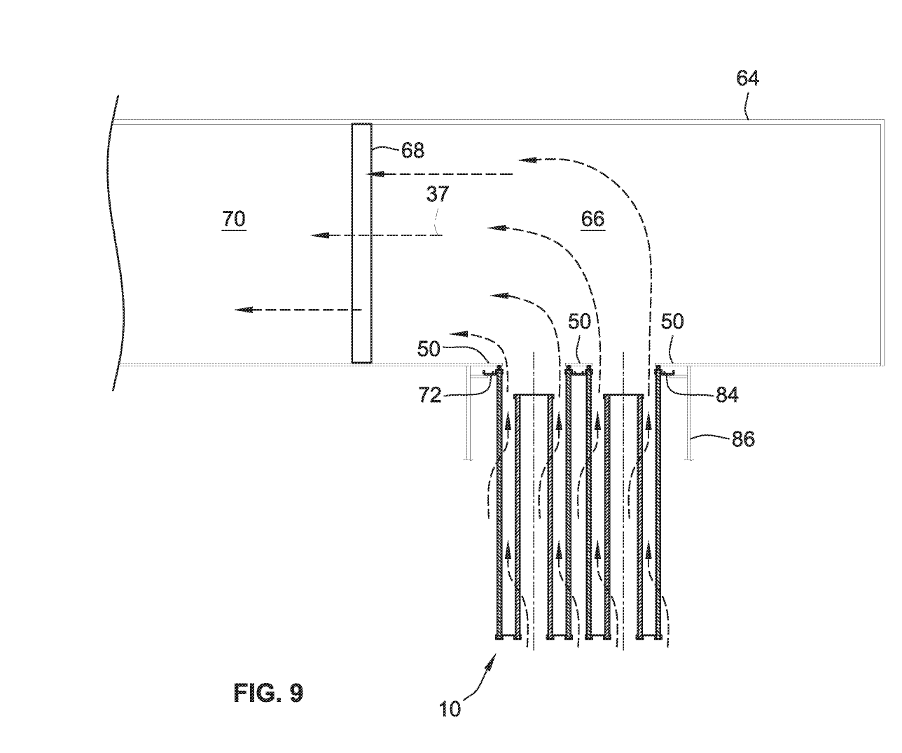

Referring to FIGS. 8 and 9, embodiments of a mist coalescer unit 100 or filtration assembly 100 employing a plurality of filter cartridges 10 are shown. Filter assembly 100 includes a housing 64 having a first filtered plenum 66. A tube sheet or partition 50 separates unfiltered fluid upstream of filter cartridge 10 from a filtered plenum 66. Annular flow channel 26 of filter cartridge 10 is in fluid communication with first filtered plenum 66 within housing 68.

Filter assembly 100 may be provided with a secondary filter element 68. Following filtration of a fluid through one or more filter cartridges 10 as shown by flow arrows 36, fluid in first filtered plenum 66 may be further directed through secondary filter element 68, as shown by flow arrows 37, into second filtered plenum 70. Secondary filter 68 is thereby protected by the primary filtration provided by one or more filter cartridges 10, thus extending the operation life of secondary filter 68. Secondary filter element 68 may be any type of filter element known in the art, such as a high-efficiency particulate arrestance (HEPA) filter. In other embodiments, secondary filter 68 may have a particle removal efficiency of at least 95% for particles size 0.1 micron and larger in diameter.

Referring to FIG. 8, one or more filter cartridges 10 may be releasably mounted directly to the partition 50. Filter cartridges 10 may be releasably mounted to partition 50 as generally known in the art, including quick release latches, threaded couplings, pin lock couplings, pressure fit, snap fit, etc.

In another embodiment shown in FIGS. 4-7 and 9, outer end cap 44 is configured for installation into a generally planar header plate 72. In this embodiment, header plate 72 includes one or more openings 74 configured to receive a filter cartridge 10. Header plate openings 74 are positioned to correspond to airflow openings 76 of tube sheet 50. Though only a single filter cartridge is shown in housing 86 of FIG. 9, it will be understood that any suitable number of filter cartridges 10 may be coupled to a header plate 72 for installation in a housing 86. Header plate 72 may be supported on slide rails 84, thereby allowing header plate 72 and associated filter cartridges 10 to be slid in and out of a filter housing 86 to place plate openings 74 and filter cartridges 10 in alignment with opening 76 in tube sheet 50.

Outer end cap 44 includes a radial flange 78 supporting filter cartridge 10 on header plate 72. Radial flange 78 includes a centering detent 80 sized to fit within header plate opening 74 of header plate 72. Centering detent 80 may include a tapered transition 82. Tapered transition 82 is provided as an annular surface on radial flange 78, tapering inwardly when moving in the direction from second end 16 to first end 14 of filter tube 12, to thereby self-center filter cartridge 10 within opening 74 of header plate 72. Outer end cap 44 is further provided with an axially-oriented compression gasket 49. As shown, axially-oriented compression gasket 49 is axially aligned with upper end 16 of outer filter tube 12. In other embodiments, axially-oriented compression gasket 49 may be positioned radially inwards or radially outwards from outer filter tube 12.

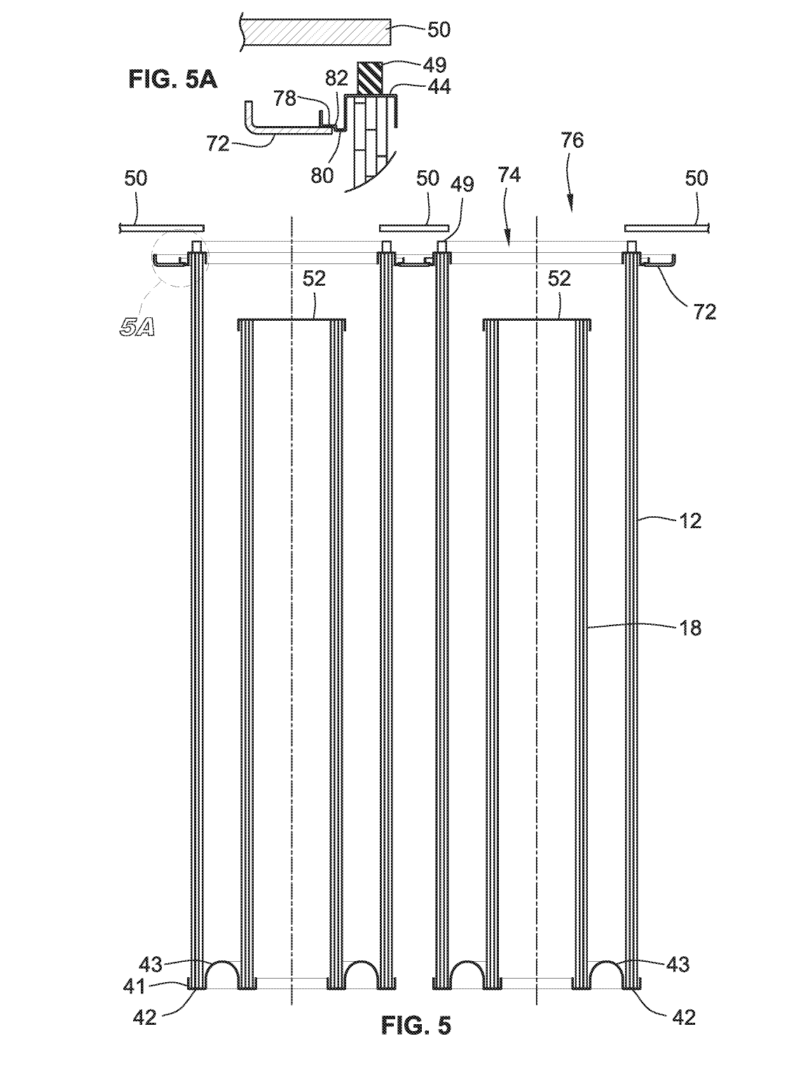

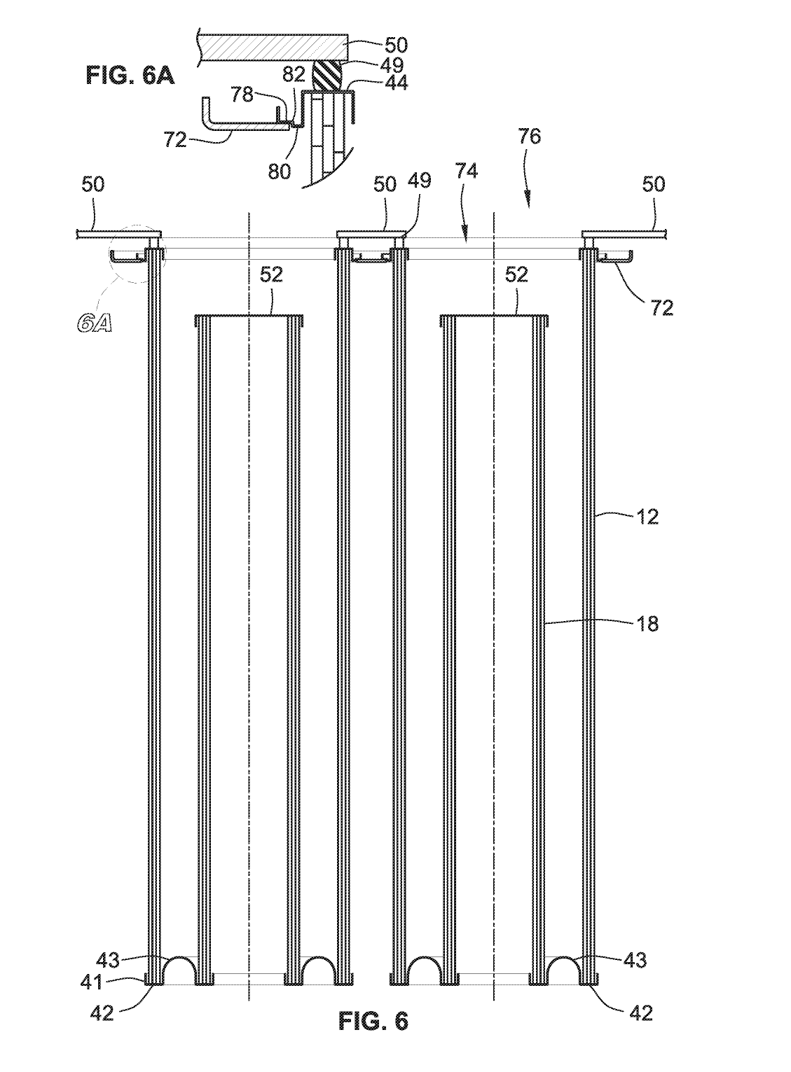

Referring to FIGS. 5 and 6, in some embodiments lower end cap 42 may be provide with a domed or otherwise elevated inner surface 43 or barrier 43 positioned between outer tube 12 and inner tube 18. Advantageously, in this embodiment dome 43 provides for self-centering during assembly and manufacture of an otherwise non-flexible or rigid coalescing filter tubes, both for outer filter tube 12 and inner filter tube 18.

Lower end cap 42 further includes an outer rim 41. As a liquid mist is coalesced by the action of filter tube 12, 18, liquid droplets permeating the filter mediums will combine into larger droplets and gravitationally drain toward the lower end 14 of filter tube 12 and toward lower end 20 of filter tube 18, respectively. Domed inner surface 43 extends upwards into annular flow channel 26 and is higher than outer rim 41 in the direction of upper ends 16, 22, thereby urging drained liquid towards upstream flow faces 38 of filter tubes 12, 18 rather than in to annular flow channel 26.

One or more filter cartridges 10 are installed in header plate 72 for coupling to tube sheet 50. In FIGS. 5 and 5A, header plate 72 is shown in a first lowered position proximate to tube sheet 50 with one or more filter cartridges 10 installed in respective openings 74.

Once header plate 72 and filter cartridges 10 are positioned proximate to tube sheet 50, header plate 72 is urged upwards in the direction of tube sheet 50 to a second position, as shown in FIGS. 6 and 6A. When header plate 72 and filter cartridges 10 coupled to header plate 72 are placed in the second position, axially-oriented gaskets 49, if used, may be compressed between tube sheet 50 and end caps 44. Header plate 72 may be urged in an upward direction and into the second position by, for example, a cam mechanism, lever, threaded bolts, or any other suitable mechanism.

In various embodiments, each of the outer filter tube 12 and the inner filter tube 18 may be formed from the same or different types of filter material or media, and may be the same or different types of filter elements. For example, both may include one or more layers of a surface-loading type media.

In a typical embodiment, outer filter tube 12 and inner filter tube 18 are the same type of media configured to provide equivalent filtration in parallel flow paths. In other embodiments, inner tube 18 may be provided with different filtration properties from outer tube 12, such as a greater flow resistance than outer tube 12 or a lesser flow resistance than outer tube 12.

More preferably, each filter tube 12, 18 is a depth-loading type of filter media having several layers of depth loading media. As such, fluid flow must pass through or along several layer of filter media to pass from an inlet face to an outlet face to facilitate several stages or opportunities for coalescing.

Each of the filter tubes 12, 18 may be configured for coalescing and particulate filtration, or each may include membrane-type filter media (e.g., polymer films with specific pore ratings), nano-type filter media, or other filter media type known in the art. Thus, the outer filter tube 12 may include any one of these or any other suitable type of filter media, while the inner filter tube 18 may also include any one of these or any other suitable type of filter media.

In a preferred embodiment, the outer filter media tube 12 and the inner filter media tube 18 are each formed from non-pleated depth filtration medias having a radial thickness of at least 0.20 inches, i.e., as measured between an upstream face and a downstream face of the filter media. In some embodiments, the non-pleated depth filtration medias have a radial thickness of between about 0.20 inches to about 1.0 inches.

Preferably, the filter tubes 12, 18 are rigid, with the layers laminated such that the tubes do not deform or collapse when subjected to 10 lbs of squeeze pressure applied to the outside of the tubes, and preferably do not include support liners or cores.

In some embodiments, filter tubes 12, 18 are PEACH® (PECO® Engineered Applied Conical Helix) wrapped, laminated filter tubes such as described in U.S. Pat. No. 5,827,430, assigned to Perry Equipment Corporation of Mineral Wells, Tex., the entire disclosure of which is hereby incorporated by reference in its entirety. Additionally, it is envisioned that the outer filter tube 12 and inner filter tube 18 may include filter media formed by the methods disclosed in U.S. Pat. No. 5,893,956, assigned to Perry Equipment Corporation of Mineral Wells, Tex., the entire disclosure of which is hereby incorporated by reference in its entirety.

Filter tubes 12, 18 include spirally wound non-woven filter elements. Tubular filters 12, 18 have a hollow core and the filter wall is made up of multiple overlaps of the nonwoven fabric sheets, shown as separate layers 54, 56, 58, 60. Each sheet is self-overlapped and compressed to overlap another sheet, and the individual sheets are selected to have different porosities and densities. These individual filter media sheets are made with a variety of bi-component and staple fibers blended in varying proportions and thermally bonded to form a non-woven fiber mat. In some embodiments, each layer of filter tubes 12, 18 includes both a bicomponent fiber and a staple fiber.

This nonwoven fabric of filter tubes 12, 18 is known as PEM (PECO® Engineered Media). The Frazier® Differential Pressure Air Permeability Measuring Instrument is commonly used to measure air permeability of PEM. PEM can be made from 1-200 denier size fibers. In some embodiments, each layer includes fibers between 1 and 50 denier. In preferred embodiments, each layer includes fibers between 1 and 20 denier. The resulting PEM may have an air permeability ranging from 100-700 CFM. This wide range of air permeability of PEM is primarily due to fiber sizes and fiber mixes used to develop the PEM. Fibers of different sizes and surface energies can be selected to design filter tubes 12, 18 using PEACH media suitable for specific applications.

Filter tubes 12, 18 are preferably provided with one or more cylindrically or helically wrapped layers of a filter media. In preferred embodiments, the non-pleated depth media of filter tubes 12, 18 is provided without a support layer or core. In other embodiments, filter rubes 12, 18 may include an additional support layer or core. A support layer or core may provided at downstream surfaces 40 of filter tubes 12, 18, or may be provided between two otherwise adjacent layers of filter media. A support layer or core may be, for example, a perforated tube, expanded metal, wire mesh, or any suitable mechanically reinforcing material. In some embodiments, each filter tube 12, 18 includes between 3 to 6 layers of wrapped filter media. In one embodiment, each filter tube 12, 18 includes 4 or 5 layers of wrapped filter media.

Most preferably, no support layers or cores are included within filter tubes 12, 18. Preferably, the non-pleated multilayer laminated wrapped media is self-supporting.

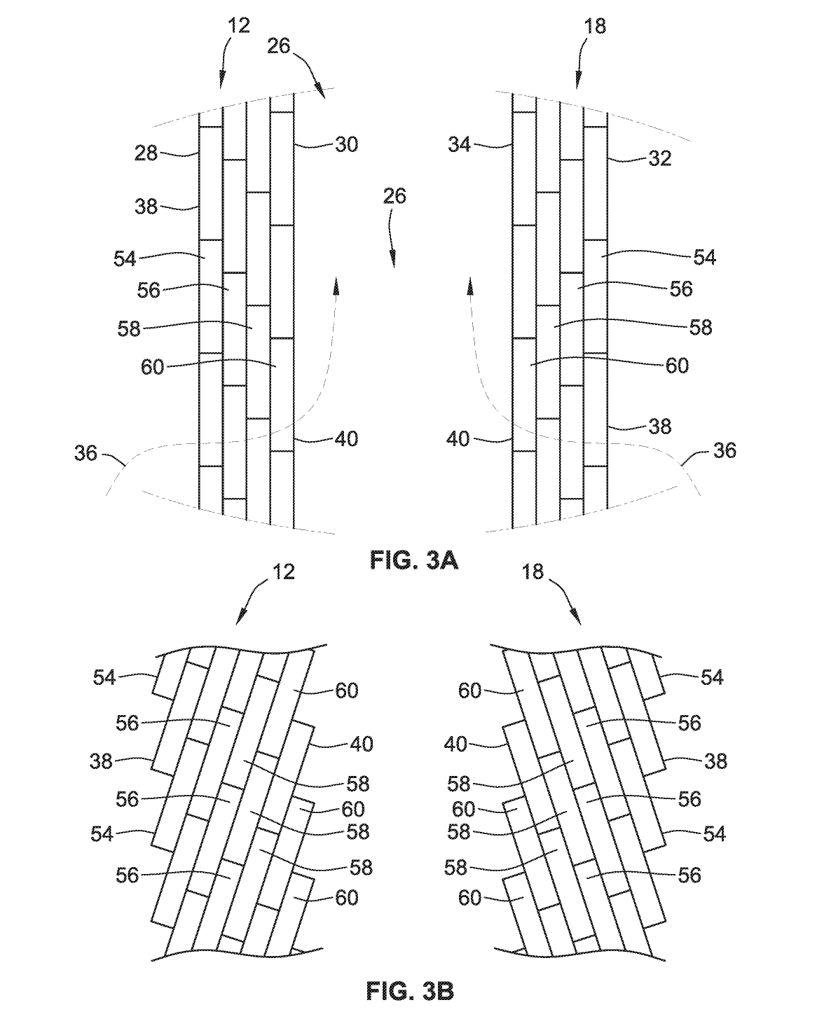

In an exemplary embodiment shown in FIG. 3A, filter tubes 12, 18 are wrapped, laminated filter tubes having 4 filter layers or bands 54, 56, 58, and 60, proceeding in the direction from upstream surface 38 to downstream surface 40. As shown in FIG. 3A, each band 54, 56, 58, 60 is helically wound without overlap. Each filter layer 54, 56, 58, 60 may be composed of selected polymeric fibers such as polyethylene, polypropylene, polyetrafluoroethylene (PTFE), etc. Each filter layer may be a woven or non-woven material, and may be formed from a single fiber type, a bicomponent fiber, or a mixture of fiber types. Suitable filter materials may be selected for compatibility with the fluid being filters, and are generally known to those of skill in the art. Each filter layer 54, 56, 58, 60 may have the same or different particle removal ratings.

One or more of filter layers 54, 56, 58, 60 may also be treated with coating as is generally known in the art to provide the filter layer material with specific properties, for example to render the filter layer material hydrophobic, hydrophilic, oleophobic, and/or oleophilic, as required for particular types of filtering operations. In some embodiments having multiple layers, a first layer may be treated to provide a first property, and a second layer may be treated to provide a second property complementary to the first property, for example a hydrophilic first layer and a hydrophobic second layer, or an oleophilic first layer and an oleophobic second layer.

In the exemplary embodiment shown in FIG. 3A, first filter tube 12 includes an outermost first filter layer 54 which is laminated radially outwardly from innermost fourth filter layer 60, and the second filter tube 18 includes an innermost first filter layer 54 which is laminated radially inwardly from the outermost fourth filter layer 54. Accordingly, the filtration properties of first filter tube 12 and second filter tube may be matched to provide equivalent filtration properties in the parallel flow paths through either of filter tube 12 or filter tube 18.

In another embodiment shown in FIG. 3B, filter tubes 12, 18 are wrapped, laminated filter tubes again having 4 filter layers or bands 54, 56, 58, and 60, proceeding in the direction from upstream surface 38 to downstream surface 40. As shown in FIG. 3B, each band is helically wrapped such that it partially overlays the preceding wrap of the same layer. As also shown in FIG. 3B, the wrapping direction and media layers of filter tube 12 may be mirrored from the wrapping direction and layers of filter tube 18.

In one embodiment, filter tubes 12, 18 include a depth technology media with a thickness ranging from 0.2 to 1.0 inches at a droplet removal rating of 1 to 10 microns and larger. The depth technology media is selected to coalesce liquids from a fine mist entrained in an air flow 36. In a typical embodiment, the depth technology media is non-pleated.

In one exemplary embodiment, outer tube 12 of filter cartridge 10 is constructed by using four PEACH stations, as disclosed in U.S. Pat. No. 5,893,956, assigned to Perry Equipment Corporation of Mineral Wells, Tex., the entire disclosure of which is hereby incorporated by reference in its entirety. A different PEM may be used on each PEACH station. Regarding filter tube 12, first layer 54 (i.e., at radially outward face 28/upstream flow face 38 of filter tube 12) is provided with 4 overlapping wraps of non-woven filter media comprising polyester fibers between about 2 to 5 denier, and about 6 to 16 denier. Second layer 56 is provided with 4 overlapping wraps of non-woven filter media comprising polyester fibers between about 1 to 2 denier, and about 3 to 6 denier. Third layer 58 is provided with 3 overlapping wraps of non-woven filter media comprising polyester fibers between about 2 to 6 denier, and about 12 to 18 denier. Fourth layer 60 (i.e., at radially inward face 30/downstream flow face 40 of filter tube 12) is provided with 5 overlapping wraps of non-woven filter media comprising polyester fibers between about 10 to 12 denier, and about 13 to 18 denier. Together, wrapped layers 54, 56, 58, 60 give a tubular filter construction 12. The first layer 54 has an air permeability as assembled of about 350-450 CFM, second layer 56 has an air permeability as assembled of 150-200 CFM, third layer 58 has air permeability as assembled of 300-400 CFM, and fourth layer has air permeability as assembled of 600-700, each at a pressure drop of 1 psi when measured using a Frazier Differential Pressure Air Permeability Measuring Instrument. As combined, the layers of filter tube 12 may have an air permeability of between about 25 to 200 CFM. In more preferred embodiments, the layers of filter tube 12 may have an air permeability of between about 40 to 100 CFM.

In one exemplary embodiment, inner tube 18 of filter cartridge 10 is also constructed by using four PEACH stations. Regarding filter tube 18, first layer 54 (i.e., at radially inward face 32/upstream flow face 38 of filter tube 18) is provided with 4 overlapping wraps of non-woven filter media comprising polyester fibers between about 2 to 5 denier, and about 6 to 16 denier. Second layer 56 is provided with 4 overlapping wraps of non-woven filter media comprising polyester fibers between about 2 to 5 denier, and about 6 to 16 denier. Third layer 58 is provided with 3 overlapping wraps of non-woven filter media comprising polyester fibers between about 2 to 6 denier, and about 12 to 18 denier. Fourth layer 60 (i.e., at radially outward face 34/downstream flow face 40 of filter tube 18) is provided with 5 overlapping wraps of non-woven filter media comprising polyester fibers between about 10 to 12 denier, and about 13 to 18 denier. Together, wrapped layers 54, 56, 58, 60 give a tubular filter construction 18. The first layer 54 has an air permeability as assembled of about 350-450 CFM, second layer 56 has an air permeability as assembled of 150-200 CFM, third layer 58 has air permeability as assembled of 300-400 CFM, and fourth layer has air permeability as assembled of 600-700, each at a pressure drop of 1 psi when measured using a Frazier Differential Pressure Air Permeability Measuring Instrument. As combined, the layers of filter tube 18 may have an air permeability of between about 25 to 200 CFM. In more preferred embodiments, the layers of filter tube 18 may have an air permeability of between about 40 to 100 CFM.

In some embodiments, inner tube 18 may have an air permeability that is between 1 and 50 CFM greater than outer tube 12, and preferably between 10 and 25 CFM greater than outer tube 12. In other embodiments, inner tube 18 may have an air permeability that is between 1 and 50 CFM lesser than outer tube 12, and preferably between 10 and 25 CFM lesser than outer tube 12.

In one embodiment, the first and second cylindrical filter tubes 12, 18 of filter cartridge 10 each have a length of between 1 and 4 feet. The first tube 12 is generally cylindrical, and preferably a right cylinder, with an inner diameter of between about 4 to 10 inches. The second tube 18 may have an inner diameter between about 2 to 6 inches. The second tube 18 is nested inside the first tube 12 such that the separation between inward face 30 and outward face 34 (i.e., the width of annular flow channel 26) is between about 1 to 3 inches, and preferably about 2 inches.

In one embodiment of a coalescing filter, each tube 12, 18 of filter cartridge 10 has an overall particle or droplet removal efficiency of greater than 75% for particles or droplets 0.1 micron or larger. In more preferred embodiment, each tube 12, 18 of filter cartridge 10 has an overall particle or droplet removal efficiency of greater than 90% for particles or droplets 0.1 micron or larger. In most preferred embodiments, each tube 12, 18 of filter cartridge 10 has an overall particle or droplet removal efficiency of greater than 95% for particles or droplets 0.1 micron or larger.

In other embodiments, each filter tube 12, 18 will filter as air or gas flow containing an aerosol mist at an upstream concentration of up to 25 mg/m³, 25-50 mg/m³, or 50-100 mg/m³ to a downstream concentration of less than 5 mg/m³, as measured by a Welas 3000 optical particle sizer, with upstream and downstream samples taken at a laminar flow, isokinetic sample point.

Many different fluid types may be efficiently filtered, coalesced, separated, etc., including liquids, gases, mixtures, suspensions, solutions, etc., using different combinations of a filter cartridge 10 and secondary filter 68. The filter media of the outer and inner filter tubes 12, 18 may include the same types of filter media to provide equivalent filtration in parallel flow paths through filter cartridge 10. Thus, various different combinations of filter tubes 12, 18 with secondary filter 68 may be used, providing for flexibility in filtering and efficient removal of particulates and aerosols.

Additionally, for example, should one of the filters 10 or 68 wear more quickly, the element 10, 68 experiencing higher wear rates may be replaced without replacing the remaining element 68, 10 that may have worn less quickly. Thus, various types of fluids containing various types of contaminants may be filtered using an embodiment of a multi-stage filter element assembly 100 as shown in FIGS. 8 and 9.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter cartridge, comprising:
a first cylindrical filter element having first and second circular ends;
a second cylindrical filter element arranged in parallel fluid circuit with the first cylindrical filter element, wherein fluid flowing through the filter cartridge flows through either the first cylindrical element or the second cylindrical filter element, the second cylindrical element having third and fourth circular ends, the second cylindrical element telescopically nested inside of the first cylindrical filter element with a cylindrical flow channel therebetween;
a first end cap, the first end cap capping the first circular end and the third circular end of the first and second cylindrical filter elements, respectively;
a second end cap, the second end cap capping the second circular end of the first cylindrical filter element; and
a third end cap, the third end cap capping the fourth circular end of the second cylindrical filter element.

2. The filter cartridge of claim 1, wherein the first cylindrical filter element and second cylindrical filter element each comprise multiple layers of laminated filter media in a wrapped configuration.

3. The filter cartridge of claim 2, wherein the first cylindrical filter element includes at least a first media material and a second media material, the first media material being laminated radially outward from the second media material, and the second cylindrical filter element includes at least the first media material and the second media material, the first media material being laminated radially inward from the second media material.

4. The filter cartridge of claim 1, wherein the first cylindrical filter element comprises at least two layers of laminated filter media with at least two different removal ratings.

5. The filter cartridge of claim 1, wherein the first cylindrical filter element is a non-pleated depth media with a thickness of at least 0.20 inches measured from an upstream face to a downstream face.

6. The filter cartridge of claim 5, wherein the non-pleated depth media does not include a support layer or core.

7. The filter cartridge of claim 5, wherein the non-pleated depth media includes at least two layers.

8. The filter cartridge of claim 7, wherein the non-pleated depth media includes between 3 to 6 layers.

9. The filter cartridge of claim 7, wherein at least one of the at least two layers includes an oleophilic or hydrophilic coating.

10. The filter cartridge of claim 1, wherein the filter media of the first cylindrical filter element is a droplet coalescing filter media.

11. The filter cartridge of claim 1, wherein the filter media is a depth media including a first wound filter layer and a second wound filter layer downstream of the first wound filter layer, the second wound filter layer having a higher particle removal rating than the first wound filter layer.

12. The filter cartridge of claim 11, wherein the first end cap comprises an annular dome positioned between the first cylindrical filter element and the second cylindrical filter element.

13. A method of filtering an air flow having liquid droplets in the air flow, including the steps of providing a filter cartridge according to claim 1, coalescing the liquid droplets from the air flow, and draining the coalesced liquid droplets from a bottom end of the filter cartridge, and providing a secondary filter element downstream of the filter cartridge wherein the secondary filter element has a higher particle removal rating than the filter cartridge.

14. A filter cartridge comprising:
a first non-pleated annular filter element having first and second annular ends;
a second non-pleated annular filter element arranged in parallel fluid circuit with the first filter element, wherein fluid flowing through the filter cartridge flows through either the first element or the second filter element, the second element telescopically nested inside of the first filter element with a flow channel therebetween, the second non-pleated annular filter element having third and fourth annular ends;
wherein the each of the first and second non-pleated annular filter elements comprise coalescing filter media, the coalescing filter media being in the form of a tube having a thickness of at least 0.2 inch between an upstream face and a downstream face,
a first end cap, the first end cap capping the first annular end and the third annular end of the first and second filter elements, respectively;
a second end cap, the second end cap capping the second annular end of the first filter element; and
a third end cap, the third end cap capping the fourth annular end of the second filter element.

15. The filter cartridge of claim 14, wherein the second end cap comprises a radial support flange.

16. The filter cartridge of claim 15, wherein the radial support flange comprises an annular centering taper.

17. The filter cartridge of claim 14, wherein the second end cap further comprises an axially-oriented sealing member.

18. A method of filtering an air flow having liquid droplets in the air flow, including the steps of providing a filter cartridge according to claim 14, coalescing the liquid droplets from the air flow, and draining the coalesced liquid droplets from a bottom end of the filter cartridge, and providing a secondary filter element downstream of the filter cartridge wherein the secondary filter element has a higher particle removal rating than the filter cartridge.

19. An air filtration assembly comprising:
a housing;
a header plate supported by the housing, the header plate including a first plurality of openings;
a plurality of filter cartridges, wherein each filter cartridge includes a first filter element and a second filter element, the second filter element telescopically nested within the first filter element and arranged in parallel fluid circuit with the first filter element, and wherein each filter cartridge further includes a mounting flange and an axial sealing member;
a tube sheet having a second plurality of openings;
wherein each filter cartridge of the plurality of filter cartridges is coupled to the header plate by its respective mounting flange to an opening of the first plurality of openings,
wherein the header plate is moveable between a first position and a second position,
and wherein the axial sealing member of each filter cartridge is in sealing compression contact with the tube sheet at an opening of the second plurality of openings when the header plate is in the second position.

20. The filtration assembly of claim 19, further comprising a secondary filter element downstream of the plurality of filter cartridges.

21. The filtration assembly of claim 20, wherein the secondary filter element has a higher particle removal efficiency rating than the plurality of filter cartridges.
